(19) United States
(12) Patent Application Publication
(10) Pub. No.: US 2005/0178059 A1
(43) Pub. Date: Aug. 18, 2005

(54) Hanging in-rail planter for deck & porch railings

(76) Inventor: J. Richard Braun, Blatimore, MD (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 10/777,701

(22) Filed: Feb. 12, 2004

(51) Int. Cl. A01G 9/02; A01G 5/04

(52) U.S. Cl. 47/67

(57) ABSTRACT

A planter receptacle for suspension from the railing of a deck, porch, or patio. The planter receptacle hangs from the railing top and at least partially enwraps the railing balusters to stabilize the planter receptacle. The position of the planter receptacle can be adjusted to accommodate the vertical height of flowers and plants, and improve viewing from both sides of the railing throughout the growing season. The planter receptacle can be constructed and finished to coordinate in appearance with the railing or the structure to which the railing is attached.

### BACKGROUND OF THE INVENTION

1. Field of the Invention

This invention relates generally to receptacles for holding plants. In particular, the present invention relates to a planter receptacle that can be suspended from a deck or porch railing to hang below such railing at a variable height.

2. Background of the Art

Flowers and plants customarily are used to improve the aesthetic appeal and attractiveness of a home or yard. Outdoor flowers and plants, in particular, are susceptible to flourishing and beautifying a surrounding area when subjected to appropriate climatic conditions. With the popularity of plants for decorative and landscaping purposes, people often desire to use potted plants on outside decks, porches, and patios, including railing or fencing that may extend around their perimeter, and have a range of heights that varies.

In urban environments, apartments often have small porches or balconies that residents use to relax outside, but there is little to no space to store chair cushions, magazines, or other items typically used thereon. Similarly, there is little space to place flowerpots or planters. Often, long narrow flowerpots are placed adjacent to the porch or balcony railing, or round pots are placed in corners to minimize the loss of space on the porch surface. However, planters and flowerpots placed on porch or balcony surfaces are less stable and more susceptible to tipping. They also create an obstruction and trap debris.

One approach to resolving the space problem is to place flowerpots or planters on top of the railing. However, not all railings have flat caps that would be suitable for such placement, and this too poses stability issues, particularly given the likelihood of toppling from an elevated position with resultant damage to property. Accordingly, mounting planters on top of or alongside the top portion of a railing improves stability, as for example on the balconies of condominiums, on the porches of houses, on the decks of above-ground pools, and so on. Some examples are taught in U.S. Pat. Nos. 1,852,650; 4,559,738; 4,698,936; 5,240,214; and 5,269,095. However, fastening of this type obstructs with the ability to use a railing as a support for people to hold.

To help overcome the limitations of using planters on balconies, porches, and decks, another common practice is to suspend a planter or flowerpot holder directly from the railing with a wire frame structure dimensioned to receive the entirety of the planter or flowerpot, and to hook at various points over the top of the railing. For instance, a prior railing hanger engages the upper edge of a railing or fence, and has a substantially vertical leg that extends downwardly along one side of the railing or fence, and supports a flowerpot at a desired height above the ground. The depending leg of the hanger, and the suspended flowerpot, rest against the railing or fence under the weight of the flowerpot and soil contained therein, such as shown in U.S. Pat. Nos. 1,353,853; 1,955,476; and 4,059,248. Another railing hanger used to support a flowerpot or a planter from an upright support, such as a deck railing or a fence, is described in U.S. Pat. No. 5,390,443 to Emalfarb et al. wherein a wire planter hanger suspends a planter in a fixed position from the top of a railing. However, railing tops often interfere with the view of flowers and plants in fixed hanger type planters. Further, a hanger type planter's fixed position prevents their accommodation of plant growth throughout the growing season.

From the foregoing, it is apparent that there is a need for a planter receptacle that is cost effective and easy to install, that is of greater stability than prior known planters or flowerpot holders, that can be hung from a balcony, porch, or deck railing so as to minimize encroachment on useable surface space, and that provides for adjustable height of the planter receptacle to improve viewing and accommodate plant growth throughout the growing season.

### SUMMARY OF THE INVENTION

The present invention provides a solution to the above and other problems by enabling a simply designed and affordable planter receptacle that provides easy access to growing plants while preserving deck or porch floor space.

It is an object of the present invention to provide a planter receptacle that fits most deck and porch railings and picket fencing. It is a related object of the present invention to provide a planter receptacle that is attached to the railing or fence. It is a further related object of the present invention to provide a planter receptacle that, at least partially, wraps around the railing balusters for stability.

It is another object of the invention to improve viewing of the planter receptacle, and its contained flowers or plants, from either side of the railing by providing convenient height adjustment functionality.

It is another object of the present invention to provide a planter receptacle that complements the existing finish of a balcony, deck, porch, or patio railing or fence.

This invention relates to a novel planter receptacle that can be attached to the railing. The planter receptacle hangs from the railing top and at least partially enwraps the railing balusters to stabilize the receptacle horizontally. The position of the planter receptacle can be readily adjusted vertically to improve viewing and accommodate the size of flowers and plants throughout the growing season.

The planter receptacle disclosed herein can be elevated to a variable height below the top portion of the railing. Such planter receptacle may be made from a variety of materials, including wood, plastic, composite material, or metal to match existing railing materials. Moreover, such planter receptacle may be finished to match the railing on which it is installed, or the structure to which the railing is attached. The invention enables a planter receptacle for attachment to a railing that can be mass-produced and sold for a reasonable price, and that can be made or put in place by any skilled or semi-skilled person.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 shows an illustration of a planter receptacle in perspective according to one embodiment of the present invention;

FIG. 2 shows a cutaway view of the planter receptacle of FIG. 1, along the line 2-2, and a mounting assembly of the present invention;

FIG. 3 shows a side elevational view of the planter receptacle of FIG. 1, with an alternate mounting assembly of the present invention;

FIG. 4 shows the planter receptacle of the present invention, installed in an upper position;

FIG. 5 shows the planter receptacle of the present invention, installed in a lower position;

FIG. 6 shows the planter receptacle of FIG. 1, according to an alternate construction of the present invention;

FIG. 7 shows an illustration of a planter receptacle in perspective according to one embodiment of the present invention;

FIG. 8 shows an illustration of a planter receptacle in perspective according to an alternate embodiment of the present invention;

FIG. 9 shows the planter receptacle of FIG. 8, for describing additional features of the alternate embodiment of the present invention;

FIG. 10 shows a bottom perspective view of the planter receptacle of FIG. 9; and

FIG. 11 shows the planter receptacle of FIG. 8, according to an alternate construction of the present invention.

### DETAILED DESCRIPTION OF THE INVENTION

The invention summarized above and defined by the enumerated claims may be better understood by referring to the following description, which should be read in conjunction with the accompanying drawings in which like reference numbers are used for like parts. This description of an embodiment, set out below to enable one to build and use an implementation of the invention, is not intended to limit the enumerated claims, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

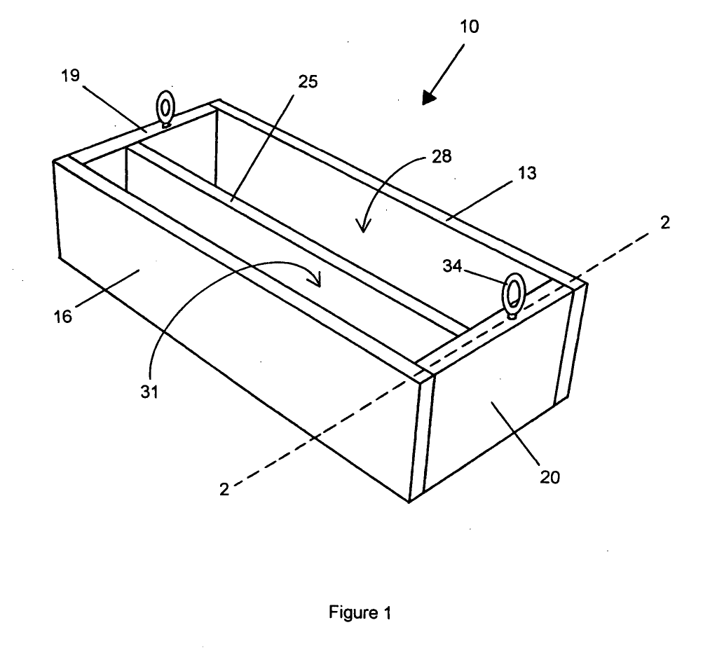

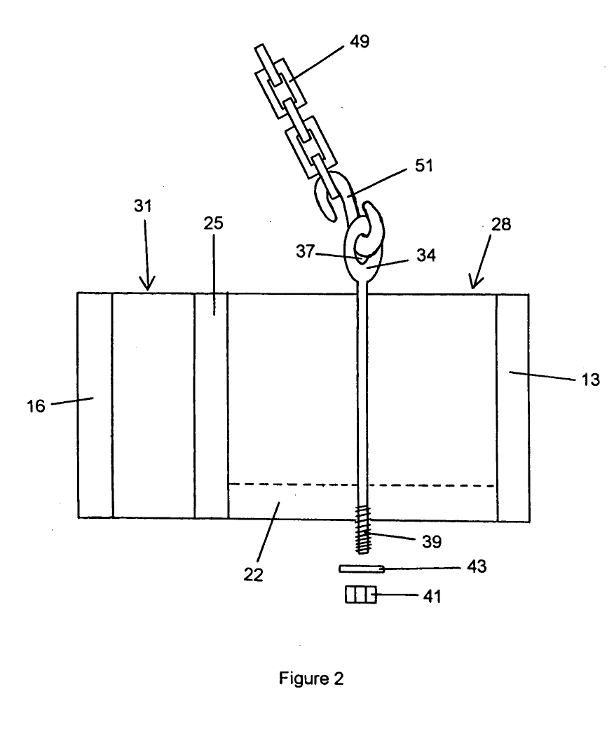

Referring to the drawings, FIG. 1 shows a single-side planter receptacle according to a first embodiment of the present invention, indicated generally as 10. Planter receptacle 10 forms an open top enclosure comprising a front wall 13, an interior wall 25, side walls 19, 20, and a bottom wall 22 (best seen in FIG. 2). An attached, adjacent second enclosure, also bounded on the side by side walls 19, 20, is formed by interior wall 25 and a back wall 16. As shown in FIG. 2, bottom wall 22 forms the underside of only the first enclosure, leaving a single planter receptacle enclosure section 28, and an open guide channel enclosure section 31. Such guide channel 31 is bounded on four sides by back wall 16, a portion of side walls 19, 20, and interior wall 25. The top and bottom of guide channel 31 is open.

Referring to FIG. 2, suspension mounting is achieved as each of side walls 19, 20 includes an eyebolt 34 disposed through such side walls 19, 20. Eyebolt 34 is sized and configured such that the eye portion 37 is situated above such side walls 19, 20, on the opposite side away from the bottom wall 22, and a threaded portion 39 of such eyebolt 34 extends below the underside of said bottom wall 22. Eyebolt 34 is securely attached to such side walls 19, 20 by suitable fasteners, such as nut 41 with washer 43. The use of a nut and washer on a threaded eyebolt, or similar device, provides the ability to level the planter receptacle, with considerable precision, at any height selected. In an alternate embodiment, eyebolt 34 may be embedded into the top of side walls 19, 20 by suitable threaded engagement. Other means of attaching such eyebolt 34 are known in the art.

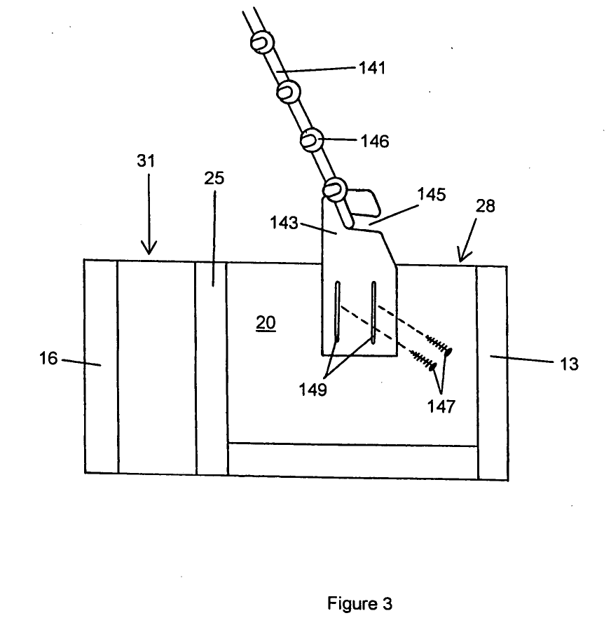

In an alternate embodiment, FIG. 3 shows a suspension mounting achieved using knotted or stopped cable length 141 together with vertically adjustable retainer slot bracket 143. Bracket 143 presents a notch 145 sized and configured to hold a stop or knot, such as 146, therein. Bracket 143 can be attached to side wall 20 by one or more screws 147. Vertical slots 149 disposed in bracket 143 enable adjustment of the position of bracket 143 with respect to side wall 20, and provide the ability to level the planter receptacle, with considerable precision, at any height selected. A similar arrangement for side wall 19 is understood. Other suspension methods, such as a thin rope and small pulleys, and other suspension materials, such as wire or readily bendable line, might also be used. Similarly, other mounting bracket types, such as a fixed non-adjustable bracket, may also be used.

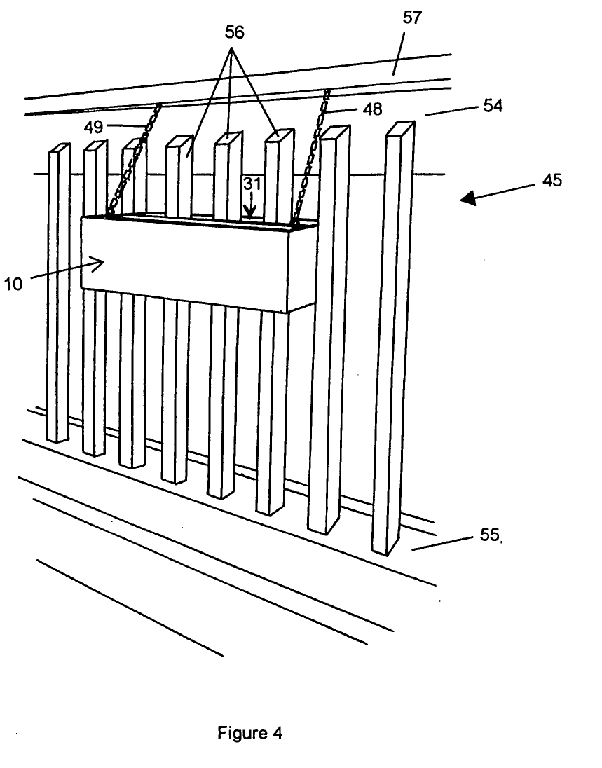

FIG. 4 illustrates a single-side embodiment of the present invention in a raised position. Planter receptacle 10 is suspended from the deck railing 45 by a pair of chains 48, 49 attached to eyebolt 34 using suitable means, such as an S hook 51 (best seen in FIG. 2). Use of such chains 48, 49, S hook 51, and eyebolt 34 provides ‘elevator’ functionality that enables such planter receptacle 10 to be positioned at any height on railing 45 by moving the end of the S hook coupled to the chain to alternate link positions.

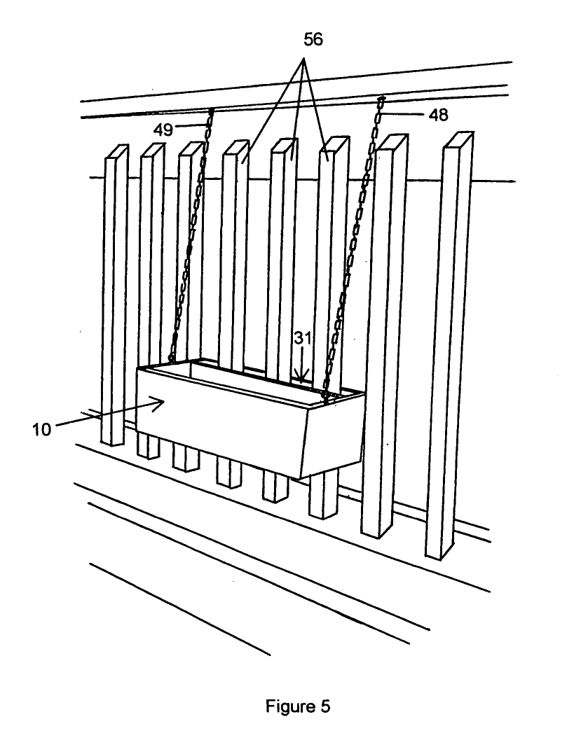

The deck railing 45 is generally comprised of a top rail 54, bottom rail 55, and balusters 56. Top rail 54 is sometimes covered by rail cap 57 substantially perpendicular to top rail 54. Railing construction is generally known in the art. As shown in FIGS. 4 and 5, chains 48, 49 are connected to the underside of rail cap 57, or to top rail 54, on the end opposite that coupled to planter receptacle 10, using a suitable connecting means such as a hook or screw. This method is most suitable for wood and certain composite construction top rails. For alternate construction top rails (i.e., metal), chains 48, 49 might simply be looped around top rail 54 and joined together using suitable fastening means such as an S hook (not shown). Balusters 56 are bounded within guide channel 31 to provide horizontal stability for planter receptacle 10. Such design is suitable for any vertical baluster railing, including railings for porches, decks, and patios, regardless of the railing composition material, and is also suitable for picket fencing. The design also permits the installation of multiple planter receptacles on the same suspension chains (stacking) for taller railings and picket fences.

FIG. 5 illustrates the single-side embodiment of the present invention in a lowered position.

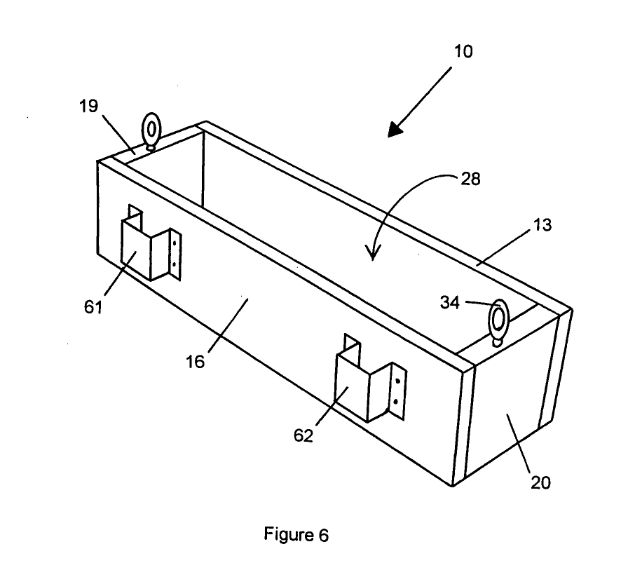

An alternate embodiment of the present invention is illustrated in FIG. 6. Planter receptacle 10 forms an open top enclosure comprising a front wall 13, a back wall 16, side walls 19, 20, and a bottom wall (not shown), leaving a receptacle enclosure section 28. Each of side walls 19, 20 includes an eyebolt 34 securely attached to such side walls 19, 20 by suitable fasteners. Eyebolt 34 may be embedded into side walls 19, 20 by suitable threaded engagement. Other means of attaching such eyebolt 34, or a similar device, are known in the art. A pair of baluster guide sleeves 61, 62 is attached to back wall 16 and each said baluster guide sleeve 61, 62 encircles a baluster 56, to guide and provide horizontal stability for planter receptacle 10 while planter receptacle 10 is moved vertically to a hanging position along balusters 56. Other guide devices may also be used, such as U-bolts, L-brackets, or similar assemblies.

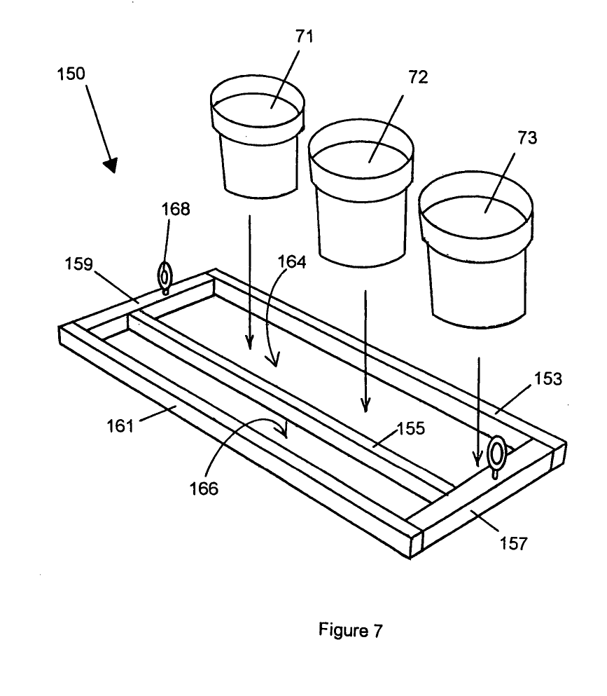

FIG. 7 shows a single-side planter receptacle according to an alternate embodiment of the present invention. In this embodiment, the planter receptacle, indicated generally as 150 is formed as similar to the planter receptacle of FIG. 1, except that all wall height dimensions are diminished, and no bottom wall is used. Planter receptacle 150 forms a flowerpot support enclosure comprising a front wall 153, an interior wall 155, and side walls 157, 159. An adjacent enclosure, also bounded on the side by side walls 157, 159, is formed by interior wall 155 and a back wall 161. There is no bottom wall, leaving a single flowerpot support enclosure section 164, and an open guide channel enclosure section 166. Such guide channel 166 is bounded on four sides by back wall 161, a portion of side walls 157, 159, and interior wall 155. The top and bottom of guide channel 166 and the top and bottom of flowerpot support enclosure section 164 are open. One or more plant containers, such as flowerpots 71, 72, 73 that are sized and configured to prevent the flowerpots 71, 72, 73 from falling through such flowerpot support enclosure section 164 can be accommodated in said support enclosure section 164. Each of side walls 157, 159 includes an eyebolt 168 securely attached to such side walls 157, 159 by suitable fasteners. Other suspension mounting methods are known in the art.

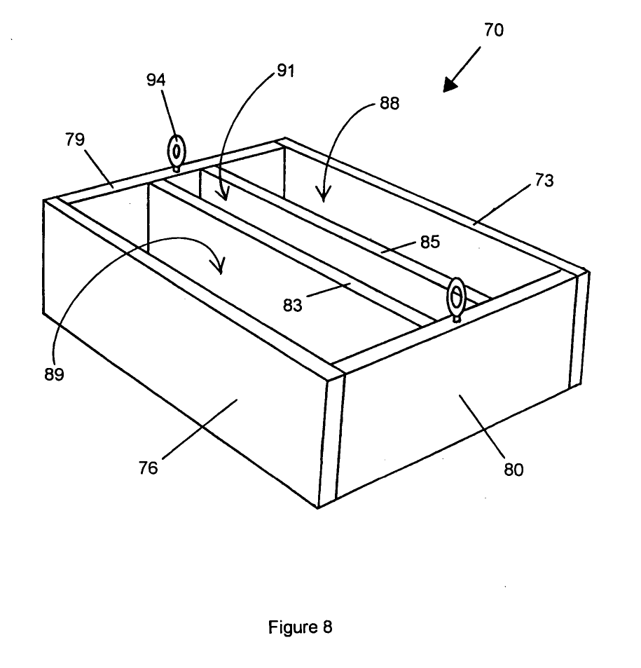

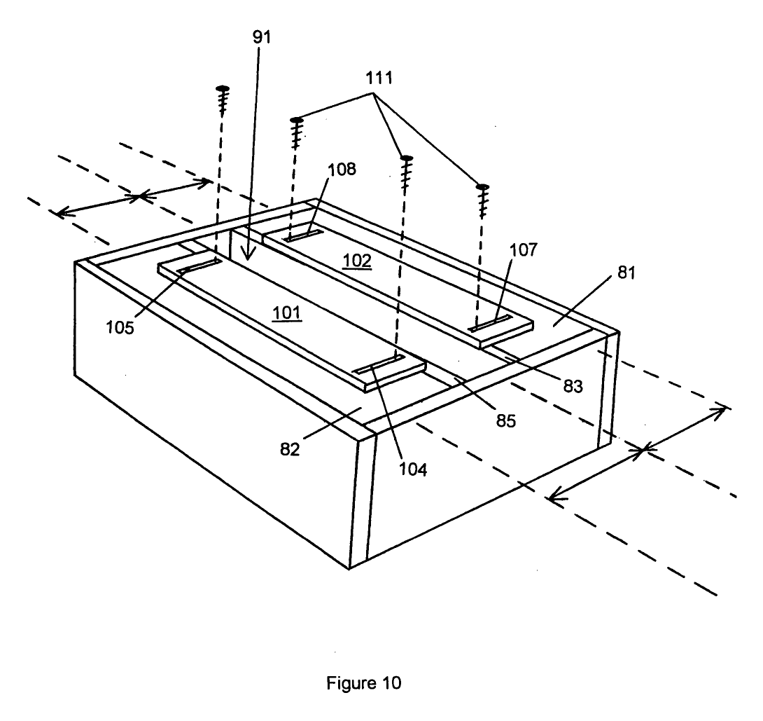

Referring to FIG. 8, an alternate double-side embodiment of the present invention, indicated generally as 70, is illustrated. Planter receptacle 70 includes two conjoined, open top enclosures: the first enclosure comprising a front wall 76, a first interior wall 83, side walls 79, 80, and bottom wall 81 (best seen in FIG. 10); the second enclosure comprising a second interior wall 85, a back wall 73, the same side walls 79, 80, and bottom wall 82 (best seen in FIG. 10). A third interior enclosure is partitioned by said first and second interior walls 83, 85 and a portion of side walls 79, 80. The bottom walls 81, 82 form the undersides for only the first two described enclosures, leaving two receptacle enclosure sections 88, 89 and an open guide channel enclosure section 91. Such guide channel 91 is bounded on four sides by a portion of side walls 79, 80, and interior walls 83, 85. The top and bottom of guide channel 91 is open. Each of side walls 79, 80 includes an eyebolt 94 securely attached to such side walls 79, 80 by suitable fasteners. Other suspension mounting methods are known in the art.

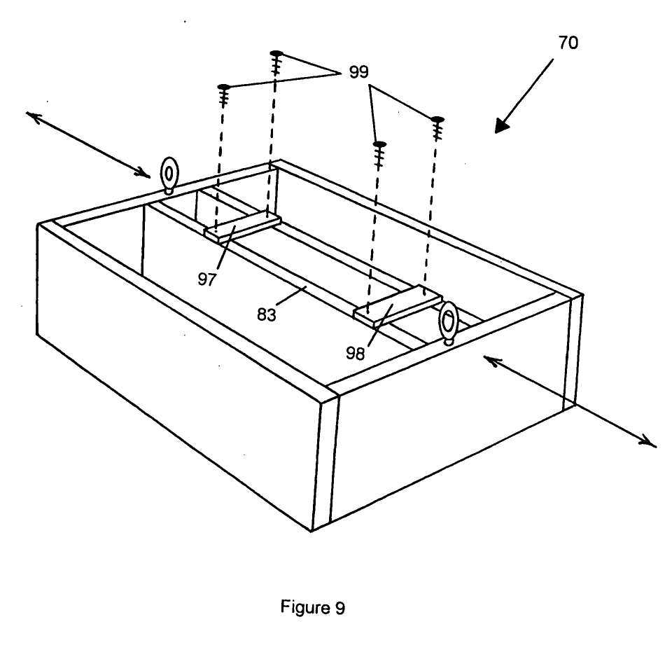

FIGS. 9 and 10 show additional features of the double-side planter receptacle 70. In FIG. 9, crosspieces 97, 98 can be attached to the top of interior walls 83, 85 using suitable fasteners, such as screws 99. Such crosspieces 97, 98 restrict motion of planter receptacle 70 in windy conditions horizontally, in the direction transverse to such crosspieces (as indicated by arrows shown in FIG. 9). The crosspieces 97, 98 can be attached in any desired position to accommodate variations in baluster placement.

In FIG. 10, adjustable baluster baffles 101, 102 can be attached to the underside of bottom walls 81, 82 or interior walls 83, 85 using suitable fasteners, such as screws 111, to enable a more stable fit when smaller diameter balusters are encountered. Such adjustable baluster baffles 101, 102 can slide in or out along slots 104, 105, 107, 108 to adjust the size of the enclosure for guide channel 91. Screws 111 are tightened to secure the baffles. Such adjustable baluster baffles 101, 102 restrict motion of planter receptacle 70 in windy conditions horizontally, in the direction transverse to such baffles (as indicated by arrows shown in FIG. 10). In the single-side embodiment shown in FIG. 1, only one adjustable baluster baffle is necessary. Additionally, the crosspieces described with reference to FIG. 9 can also be used for the single-side embodiments shown in FIGS. 1 and 7.

In either the single-side embodiments of FIGS. 1 and 7, or the double-side embodiment of FIG. 8, the receptacle enclosure sections may be sized and configured to hold a plurality of standard flowerpots as inserts. Alternatively, in either the single-side embodiment of FIG. 1, or the double-side embodiment of FIG. 8, no flowerpots are necessary and appropriate planting material and plants can be placed directly within such receptacle enclosure sections. Holes may be provided in appropriate receptacle locations to provide drainage, or the bottom walls may be sloped to an open edge to provide drainage, as necessary. Furthermore, the receptacle enclosure section(s) may be any desired shape, or the receptacle enclosure section(s) may be modified to comprise a simplified flowerpot holder (as shown in FIG. 7), or similar assembly. Placement of the eyebolts or brackets should be selected to the approximate center of the load placed within such receptacle enclosure section to evenly distribute the weight and enable easier adjustment of the height of the planter receptacle along the balusters.

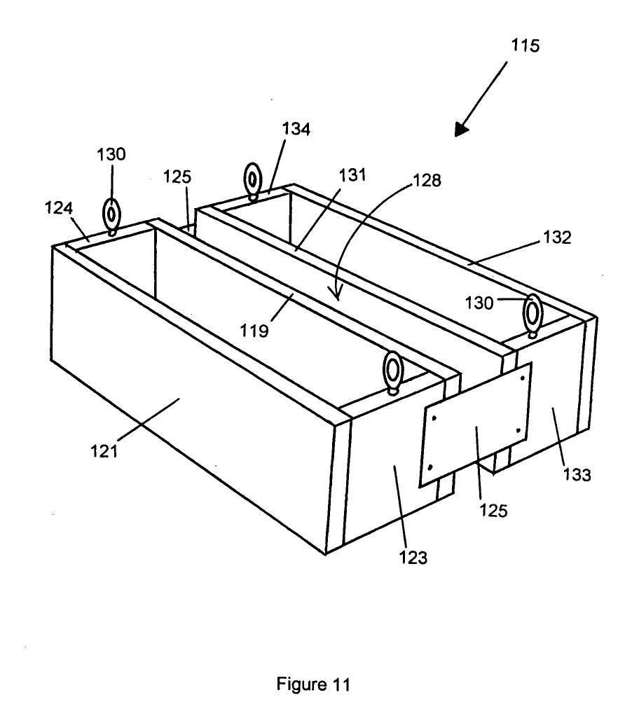

Referring to FIG. 11, an alternate double-side construction is shown. Planter receptacle 115 includes two separate, open top enclosures: a first enclosure comprising a front wall 121, an interior wall 119, side walls 123, 124, and a bottom wall (not shown); and a second enclosure comprising an interior wall 131, a back wall 132, side walls 133, 134, and another bottom wall (not shown). The two separate open top enclosures are joined by two plates 125, leaving an open guide channel enclosure 128. Such guide channel 128 is bounded on four sides by the plates 125, and the first open top enclosure interior wall 119, and the second open top enclosure interior wall 131. With such a design, four suspension chains and four eyebolts 130 are used. Such eyebolts 130 are securely attached to side walls 123, 124 and 133, 134 by suitable fasteners. Other suspension mounting methods are known in the art. For example, a bracket assembly having an integral eyebolt or retainer slot can be used to replace plates 125, thereby requiring only a single suspension chain or cable on each side. Alternatively, a short connector can connect the two eyebolts on each side, and then only a single suspension chain on each side would be required.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

1. A planter receptacle adapted to be mounted to a railing, comprising:
a front wall;
a back wall;
first and second spaced-apart side walls, wherein
a. said front wall is connected to said first and second side walls; and
b. said back wall is connected to said first and second side walls, forming an enclosure with said front wall, said back wall, and said first and second spaced-apart side walls; and
hanging means selected from the group consisting of:
chain;
cable;
rope;
wire;
readily bendable line; and
flexible length.

2. The planter receptacle of claim 1, further comprising: a bottom wall, wherein said bottom wall forms at least a portion of the underside of said enclosure formed by said front wall, said back wall, and said first and second spaced-apart side walls.

3. The planter receptacle of claim 2, further comprising:
means for stabilizing said planter receptacle with respect to said railing, wherein said stabilizing means at least partially surrounds at least one baluster and is attached to at least one wall of said planter receptacle.

4. The planter receptacle of claim 3, wherein said stabilizing means comprises:
at least a first interior wall connected to said first and second spaced-apart side walls between said front wall and said back wall, creating
a first enclosure formed by said front wall, said first interior wall, and a portion of said first and second spaced-apart side walls, and
a second enclosure formed by said first interior wall, said back wall, and a portion of said first and second spaced-apart side walls, wherein
said first interior wall, said back wall, and said portion of said first and second spaced-apart side walls at least partially surround at least one baluster of said railing when said planter receptacle is mounted to said railing.

5. The planter receptacle of claim 4, wherein said first interior wall is substantially parallel to said back wall.

6. The planter receptacle of claim 4, further comprising:
a bottom wall, wherein said bottom wall forms at least a portion of the underside of said first enclosure formed by said front wall, said first interior wall, and a portion of said first and second spaced-apart side walls.

7. The planter receptacle of claim 4, further comprising:
a second interior wall connected to said first and second spaced-apart side walls between said first interior wall and said back wall, dividing said second enclosure, creating
a third enclosure formed by said back wall, said second interior wall, and a portion of said first and second spaced-apart side walls, and
an enclosure formed by said first interior wall, said second interior wall, and a portion of said first and second spaced-apart side walls, wherein
said first interior wall, said second interior wall, and said portion of said first and second spaced-apart side walls at least partially surround at least one baluster of said railing when said planter receptacle is mounted to said railing.

8. The planter receptacle of claim 7, wherein said second interior wall is substantially parallel to said first interior wall.

9. The planter receptacle of claim 7, further comprising:
a first bottom wall, wherein said first bottom wall forms at least a portion of the underside of said first enclosure formed by said front wall, said first interior wall, and a portion of said first and second spaced-apart side walls.

10. The planter receptacle of claim 9, further comprising:
a second bottom wall, wherein said second bottom wall forms at least a portion of the underside of said third enclosure formed by said back wall, said second interior wall, and a portion of said first and second spaced-apart side walls.

11. The planter receptacle of claim 1, further comprising connecting means attached to at least one of said walls.

12. The planter receptacle of claim 11, wherein said connecting means is vertically adjustable.

13-14. (canceled)

15. The planter receptacle of claim 1, wherein said hanging means is attachable to said railing.

16. The planter receptacle of claim 1, wherein said hanging means enables said planter receptacle to be positioned at a variable height with respect to said railing.

17. The combination of a railing and a planter receptacle, said railing comprising a top rail and at least one baluster, said planter receptacle comprising:
a front wall;
a back wall;
first and second spaced-apart side walls, wherein
a. said front wall is connected to said first and second side walls; and
b. said back wall is connected to said first and second side walls, forming an enclosure with said front wall, said back wall, and said first and second spaced-apart side walls; and
hanging means selected from the group consisting of:
chain;
cable;
rope;
wire;
readily bendable line; and
flexible length.

18. The combination of claim 17, further comprising: a bottom wall, wherein said bottom wall forms at least a portion of the underside of said enclosure formed by said front wall, said back wall, and said first and second spaced-apart side walls.

19. The combination of claim 18, further comprising:
means for stabilizing said planter receptacle with respect to said railing, wherein said stabilizing means at least partially surrounds at least one baluster and is attached to at least one wall of said planter receptacle.

20. The combination of claim 17, wherein said stabilizing means comprises:
at least a first interior wall connected to said first and second spaced-apart side walls between said front wall and said back wall, creating
a first enclosure formed by said front wall, said first interior wall, and a portion of said first and second spaced-apart side walls, and
a second enclosure formed by said first interior wall, said back wall, and a portion of said first and second spaced-apart side walls, wherein
said first interior wall, said back wall, and said portion of said first and second spaced-apart side walls at least partially surround at least one baluster of said railing when said planter receptacle is mounted to said railing.

21. The combination of claim 20, wherein said first interior wall is substantially parallel to said back wall.

22. The combination of claim 20, further comprising:
a bottom wall, wherein said bottom wall forms at least a portion of the underside of said first enclosure formed by said front wall, said first interior wall, and a portion of said first and second spaced-apart side walls.

23. The combination of claim 20, further comprising:
a second interior wall connected to said first and second spaced-apart side walls between said first interior wall and said back wall, dividing said second enclosure, creating
a third enclosure formed by said back wall, said second interior wall, and a portion of said first and second spaced-apart side walls, and
an enclosure formed by said first interior wall, said second interior wall, and a portion of said first and second spaced-apart side walls, wherein
said first interior wall, said second interior wall, and said portion of said first and second spaced-apart side walls at least partially surround at least one baluster of said railing when said planter receptacle is mounted to said railing.

24. The combination of claim 23, wherein said second interior wall is substantially parallel to said first interior wall.

25. The combination of claim 23, further comprising:
a first bottom wall, wherein said first bottom wall forms at least a portion of the underside of said first enclosure formed by said front wall, said first interior wall, and a portion of said first and second spaced-apart side walls.

26. The combination of claim 25, further comprising:
a second bottom wall, wherein said second bottom wall forms at least a portion of the underside of said third enclosure formed by said back wall, said second interior wall, and a portion of said first and second spaced-apart side walls.

27. The combination of claim 17, further comprising connecting means attached to at least one of said walls.

28. The combination of claim 27, wherein said connecting means is vertically adjustable.

29-30. (canceled)

31. The combination of claim 17, wherein said hanging means is connected to said railing.

32. The combination of claim 31, said railing further comprising a rail cap, wherein said hanging means is connected to said rail cap.

33. The combination of claim 31, wherein said hanging means enables said planter receptacle to be positioned at a variable height with respect to said railing.

34. A method for mounting a planter receptacle on a railing, said railing comprising a top rail and at least one baluster, said method comprising the steps of:
1) providing a planter receptacle comprising:
a front wall;
a back wall;
first and second spaced-apart side walls, wherein
a. said front wall is connected to said first and second side walls; and
b. said back wall is connected to said first and second side walls, forming an enclosure with said front wall, said back wall, and said first and second spaced-apart side walls; and
mounting means;
2) suspending said planter receptacle from said railing; and
3) mounting said planter receptacle to said at least one baluster of said railing, wherein said mounting means at least partially surrounds at least one baluster.

35. The method of claim 35, wherein said step of suspending said planter receptacle from said railing further comprises the steps of:
2a) connecting a first end of a hanging means to said top rail; and
2b) connecting a second end of said hanging means to said planter receptacle, wherein said hanging means enables said planter receptacle to be positioned at a variable height with respect to said railing.

36. The method of claim 36, said planter receptacle further comprising:
connecting means attached to said first and second spaced-apart side walls, wherein said connecting means is vertically adjustable to enable said planter receptacle to be leveled.

37. The method of claim 36, wherein said hanging means is selected from the group consisting of:
chains;
cable;
rope;
wire; and
readily bendable line.

38. The method of claim 35, said planter receptacle further comprising:
a bottom wall, wherein said bottom wall forms at least a portion of the underside of said enclosure formed by said front wall, said back wall, and said first and second spaced-apart side walls.

39. The method of claim 35, wherein said mounting means is not attached to said at least one baluster.
